(19) United States
(12) Patent Application Publication
(10) Pub. No.: US 2017/0108590 A1
(43) Pub. Date: Apr. 20, 2017

(54) TRIPLE DIFFERENCE FORMULATION FOR FORMATION FLIGHT

(71) Applicant: Powered Boomerang, LLC, Overland Park, KS (US)

(72) Inventor: Euiho Kim, Overland Park, KS (US)

(21) Appl. No.: 14/885,571

(22) Filed: Oct. 16, 2015

(51) Int. Cl. G01S 19/51

(52) U.S. Cl. CPC G01S 19/51

(57) ABSTRACT

A system for and method of determining relative position is provided. The system includes a plurality of GNSS receivers for receiving signals from a plurality of GNSS satellites. The system also includes a launcher for positioning each receiver a known vector distance from each of the other receivers so that an initial relative position vector can be established for each receiver. The method utilizes the initial relative position vectors to determine triple differences for each receiver, thereby determining relatively accurate relative positions for each receiver. The receivers are incorporated into a plurality of devices so that the system can be utilized in controlling the movement of each device, thereby improving formation and swarming capabilities of the plurality of devices.

### FIELD OF THE INVENTION

The present invention relates generally to relative positioning technology. More specifically, the present invention is concerned with achieving precise relative positioning between two or more objects using a triple difference formulation that takes the time difference of carrier phase double difference measurements of two or more receivers associated with the objects.

### BACKGROUND OF THE INVENTION

A Global Navigation Satellite System (GNSS), such as the United States' Global Positioning System (GPS), utilizes a plurality of satellites to provide users with positioning information. By comparing the relative positioning information obtained from a plurality of satellites, a GNSS receiver is capable of determining the position of the user.

GNSS receivers include antennas for receiving signals from GNSS satellites and internal clocks for determining when the signals were received. The signals are then processed to determine GNSS codes and carrier measurements. These codes and measurements enable the GNSS receiver to unambiguously determine when the signal was sent. Because GNSS satellites maintain and transmit extremely accurate time information, a GNSS receiver is capable of determining the distance to each satellite by comparing the sent and received times for each signal. Because GNSS receivers have access to ephemerides information for the GNSS satellites (received from the GNSS satellites), a GNSS receiver is typically capable of determining its absolute position within several meters, based on its distance from at least four GNSS satellites.

Traveling at the speed of light, it takes less than a tenth of a second for a GNSS signal to reach the surface of the Earth. Consequently, even extremely small clock errors (in the satellite clock and/or in the receiver clock) can adversely affect position accuracy. Furthermore, other factors, including the Earth's atmosphere, can potentially adversely affect position accuracy. In some applications, such as formation flight applications, the position accuracy available from standard GNSS systems is inadequate.

Real Time Kinematic (RTK) GNSS is a popular method of obtaining more precise position information. The method uses dual-frequency (L1 and L2) GNSS receivers and high-grade GNSS antennas. Using the GNSS code and carrier measurements from L1 and L2 frequencies, RTK GNSS resolves integer ambiguities in the carrier measurements and directly uses carrier phase measurement to compute position information. In other words, RTK GNSS systems determine the number of carrier cycles and fractions between a receiver and each satellite. Because the length of each carrier wave is known (approximately 19 cm for L1 waves and approximately 24 cm for L2 waves), the distance between the receiver and each satellite can be determined.

Commercial RTK GNSS systems usually provide positioning accuracy within ten (10) centimeters. Unfortunately, RTK GNSS systems require heavy computation load and long initialization times of several minutes for resolving the integer ambiguities. Furthermore, RTK GNSS systems are more expensive than standard single-frequency GNSS systems. Furthermore still, cycle slips (which can occur if a receiver loses contact with a satellite even momentarily) can adversely affect the position accuracy provided by an RTK GNSS system. As a result, many RTK GNSS systems include warning systems regarding potential cycle slips. In some instances, these warnings could be false alarms. Therefore, it would be beneficial to provide a system and method for increasing position accuracy without requiring the system or method to resolve integer ambiguities. Furthermore, it would be beneficial if the system and method utilized a less expensive single-frequency GNSS system. Furthermore still, it would be beneficial if the system and method reduced or eliminated adverse effects associated with cycle slips. Furthermore yet, it would be beneficial to have a system and method of reliably detecting cycle slips that reduced or eliminated false alarms.

Unmanned aerial systems (“UASs”), such as model airplanes and drones, have become increasingly popular for a variety of applications, including recreational applications, commercial application, and even espionage and warfare. Many such applications, such as formation flight and swarming, employ at least two UASs. When relative position of each UAS is not critical, standard GNSS systems can be utilized to control the location of each individual UAS. When relative position is critical, however, such as when the UASs will be in close proximity to each other or when timing and/or spacing of UASs is otherwise important, a relative positioning system is required.

Some relative positioning systems utilize RTK GNS S. Unfortunately, as discussed above, RTK GNSS has a variety of drawbacks. Therefore, it would be beneficial to employ a relative positioning system that does not include the variety of drawbacks associated with RTK GNSS.

Other relative positioning systems utilize lasers and/or cameras mounted on one UAS to determine the relative position of another UAS. Unfortunately, many such systems require the first UAS to maintain line of sight with the second UAS. Consequently, flight formations and flight maneuvers are limited. Therefore, it would be beneficial to employ a relative positioning system that does not require a first UAS to maintain line of sight with a second UAS.

### SUMMARY OF THE INVENTION

The present invention comprises a system for and method of increasing relative position accuracy without requiring the system or method to resolve integer ambiguities. In some embodiments, the system and method utilizes single frequency GNSS signals. The present system and method accommodates formation flight, swarming technology, and/or other applications in which the relative position of two or more objects is desired, without requiring line of sight between the various devices in the formation and/or the swarm.

In some embodiments, two or more devices are positioned on a launcher having known dimensions between each device's position. Using the launcher, an initial relative position vector is established for each device. This initial relative position vector is used in triple difference calculations to obtain relatively accurate relative positions of each device. By monitoring the triple differences, cycle slips are detected and/or false cycle slip alarms are discredited.

The foregoing and other objects are intended to be illustrative of the invention and are not meant in a limiting sense. Many possible embodiments of the invention may be made and will be readily evident upon a study of the following specification and accompanying drawings comprising a part thereof Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 shows a plurality of satellites orbiting a celestial body, each satellite positioned at least a pre-determined angle above the horizon of the celestial body transmitting a signal towards the surface of the celestial body.

FIG. 2 shows first and second devices, each device being in data communication with a plurality of satellites, a position processor, a controller, and each other.

FIG. 3A is a plan view of a launcher.

FIG. 3B is a plan view of first and second devices positioned on a launcher.

FIG. 4A is a rear view of one embodiment of the launcher of FIG. 3B.

FIG. 4B is a rear view of another embodiment of the launcher of FIG. 3B.

FIG. 5 is a flow diagram of various processes of the present invention.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

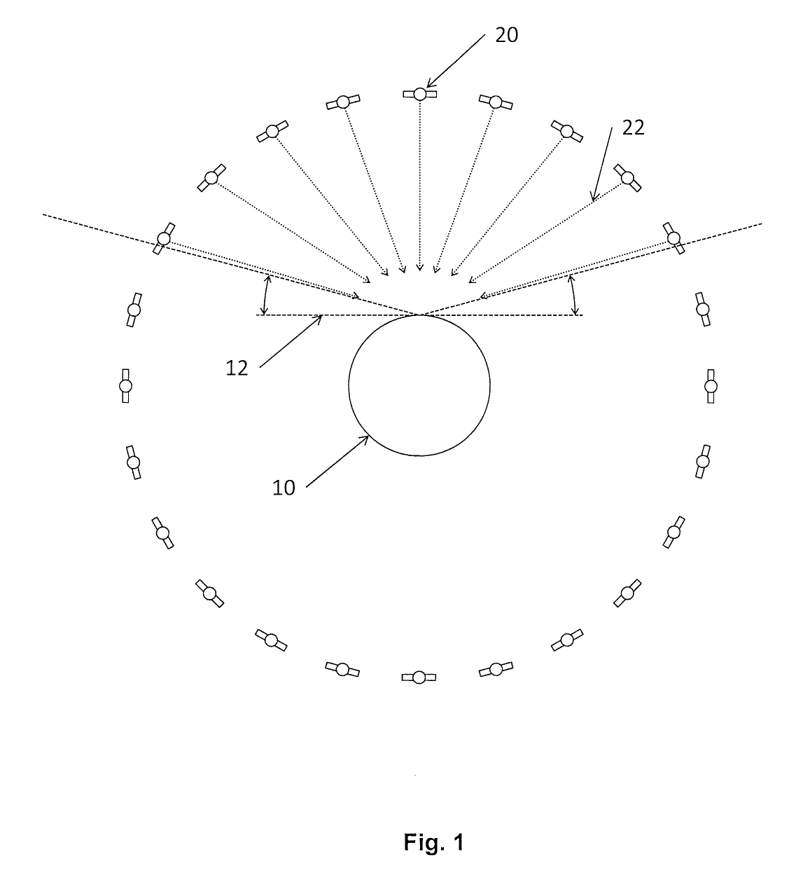

Referring to FIG. 1, a preferred embodiment of the present invention utilizes signals 22 from a plurality of GNSS satellites 20. In some embodiments, the present invention only utilizes signals 22 from satellites 20 that are positioned at least a predetermined elevation angle above the horizon 12 of a celestial body 10, such as Earth. In some such embodiments, the predetermined elevation angle is approximately fifteen (15) degrees.

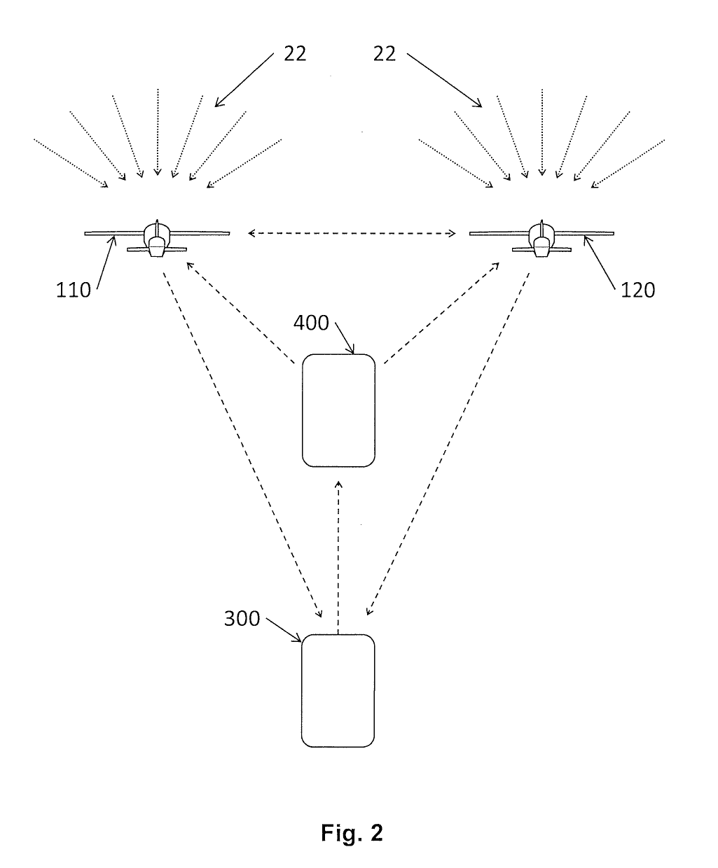

Referring to FIG. 2, a master device 110 and follower device 120 each receive at least one signal, such as an L1 carrier wave signal, from each of a plurality of GNSS satellites. In some embodiments, each device receives a signal from each of the same three GNSS satellites (common GNSS satellites). In other embodiments, each device receives a signal from each of four or more common GNSS satellites. In still other embodiments, each device receives a signal from each of the common GNSS satellites and at least one device receives additional signals from each of one or more additional GNSS satellite. In some such embodiments, each device receives additional signals from each of the one or more additional GNSS satellite.

Each of the first 110 and second 120 devices include a GNSS antenna for receiving the signals and each GNSS antenna is in communication with a receiver. In some embodiments, the receiver is positioned within and/or otherwise supported by the device. The receiver associates the signal with a received time and processes the signal to obtain a sent time and a sent location. In this way, in some embodiments, the receiver creates a packet of current information that includes satellite clock information, receiver clock information, and satellite position information.

In some embodiments, the carrier phase measurements of GNSS satellites at L1 frequency have the following expression:

Φ=r+tᵤ−tₛI+T+N+ε (Equation 1)

where r is the true range between a user and a satellite; tᵤ and tₛ are receiver and satellite clock errors; I is an ionospheric delay; T is a tropospheric delay; N is an integer ambiguity; and ε includes multipath, thermal noises, and modeling errors in carrier phase measurements.

### Single Difference Equations

In some embodiments, packets of information associated with the first 110 and second 120 devices (also referred to as master (M) and follower (F) receivers, respectively) can be utilized to determine a single difference of carrier phase measurements of a common satellite (k). In some such embodiments, such as when the first 110 and second 120 devices are located relatively close to each other, the single difference can be calculated using the following equation:

ΔΦ_{MF}^{k}=Δr_{MF}^{k}+Δtᵤ+ΔN^{k}+Δε^{K} (Equation 2)

where Δ operator is the difference of the same variable. It will be appreciated that the close proximity of the first device 110 to the second device 120 enables Equation 2 to omit the satellite clock error, the tropospheric delay error, and the ionospheric delay error, all of which are assumed to be cancelled out. In other embodiments, the difference of one or more such errors is included in Equation 2 and/or is otherwise taken into consideration.

In some embodiments, the code and carrier phase measurements in the M receiver and the F receiver are taken at a slightly different time (usually within tens of milliseconds). In some such embodiments, the carrier phase measurements must be time synched. In some embodiments, receivers output precise GNSS time information of the moment when the received code and carrier phase measurements are taken. Using the precise time and delta pseudo range measurements, the carrier phase measurements in one receiver can be synched to another through forward or backward extrapolation.

### Double Difference Equations

In some embodiments, additional packets of information associated with the first 110 and second 120 devices can be utilized to determine a double difference of carrier phase measurements of two common satellites (k and l). In some such embodiments, this is accomplished by first determining the single difference of each satellite and then comparing the single differences of each satellite using the following equation:

∇ΔΦ_{MF}^{kl}=ΔΦ_{MF}^{k}−ΔΦ_{MF}^{t}=∇Δr_{MF}^{kl}∇ΔN^{kl}+∇Δε^{kl} (Equation 3)

where ∇ΔΦ_{MF}^{kl} denotes the double difference of satellites k and l in receivers M and F. It will be appreciated that the comparison of common satellites and common receivers enables Equation 3 to omit the receiver clock error. It will also be appreciated that Equation 3 has an unknown integer ambiguity that is constant as long as the carrier phase locks of the satellites k and l are maintained in the two receivers.

In some embodiments, the double difference of the range can be expressed as

∇Δr_{MF}^{kl}=−(1_{M}^{k}−1_{M}^{t})·x_{MF} (Equation 4)

where 1_{M}^{(k)} is the direction cosine vector from the receiver M to the satellite k, 1_{M}^{(l)} is the direction cosine vector from the receiver M to the satellite 1, and x_{MF} is the relative position vector from the receiver M to the receiver F.

### Triple Difference Equations

In some embodiments, a triple difference is calculated by taking the time difference of the double difference measurements between two epochs. In some such embodiments, the integer ambiguity in Equation 3 is eliminated and/or canceled out to obtain the following expression:

$$\begin{matrix}{δΦ}_{MF}^{kl} ( t ) = ∇ {ΔΦ}_{MF}^{kl} ( t ) - ∇ {ΔΦ}_{MF}^{kl} ( 0 ) \\ = - ( {1}_{M}^{k} ( t ) - {1}_{M}^{l} ( t ) ) \cdot {x}_{MF} ( t ) + \\ ( {1}_{M}^{k} ( 0 ) - {1}_{M}^{l} ( 0 ) ) \cdot {x}_{MF} ( 0 ) + \tilde{ε}\end{matrix} \qquad ( Equation 5 )$$

Referring to Equation 5, there are two unknown relative position vectors, an initial vector, x_{MF}(0), and a current vector, x_{MF}(t). In some embodiments, especially when t is relatively small, the initial and current vectors, at time 0 and t, respectively, are very similar, likely causing a large value of dilution of precision. As a result, in some such embodiments, the direct estimation of both of x_{MF}(0) and x_{MF}(t) can yield poor results.

### Establishing an Initial Relative Position Vector

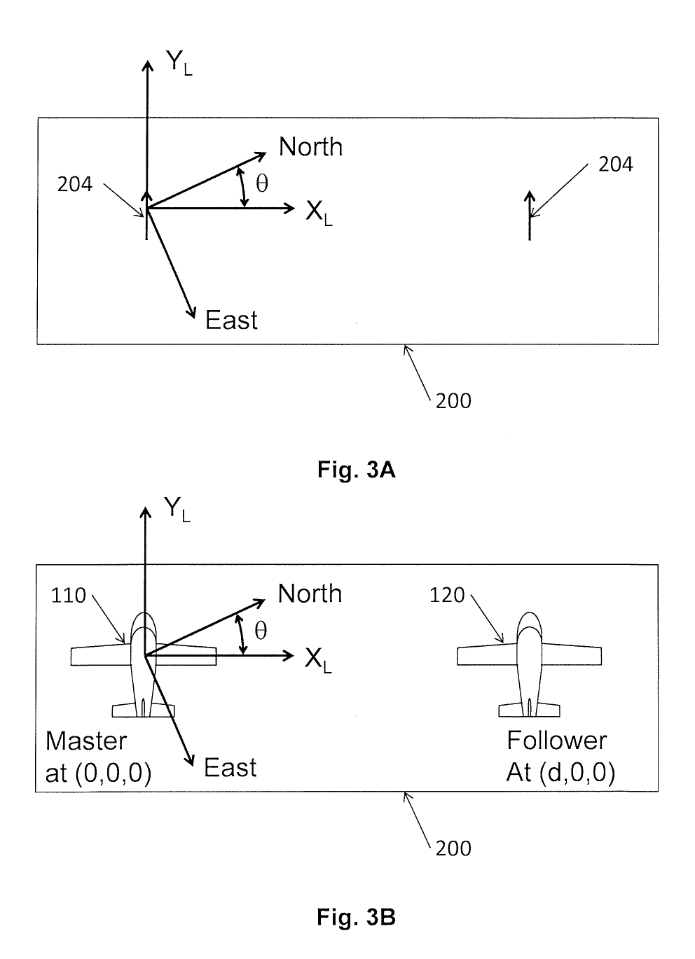

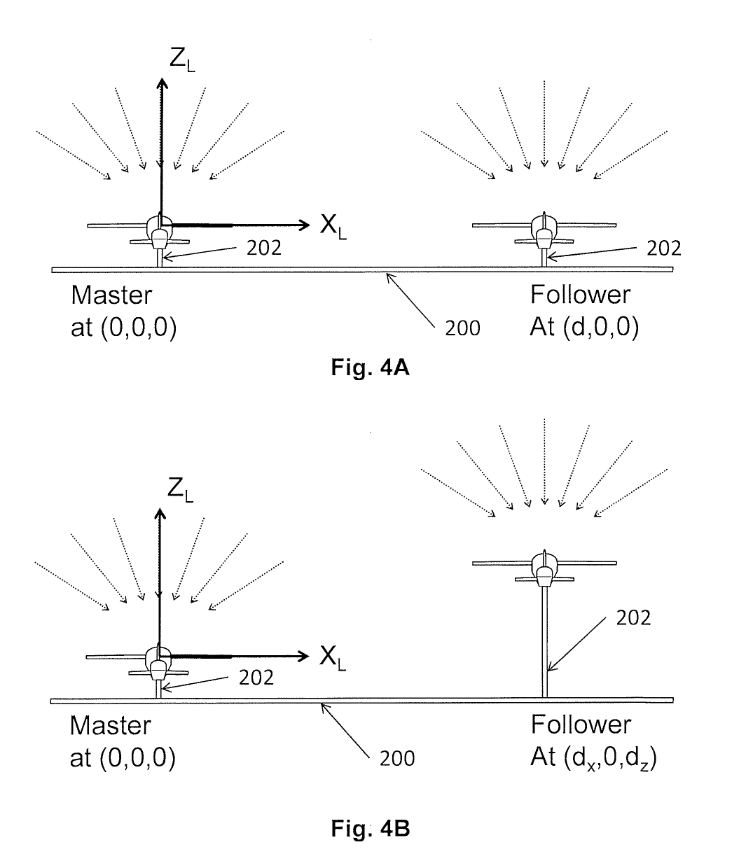

Referring to FIGS. 3A-4B, a preferred embodiment of the present invention utilizes a positioning device 200 (also referred to herein as a “launcher” 200) for positioning one or more receiver a known distance away from one or more other receiver. In some embodiments, a first device 110 is positioned at a first location of the launcher 200 and a second device 120 is positioned at a second location of the launcher 200. In some such embodiments, the second location is fixed relative to the first location such that the first 110 and second 120 devices are positioned a known fixed distance from each other. In some embodiments, a first/master receiver is coupled to the first device 110 and a second/follower receiver is coupled to the second device 120 such that when the first 110 and second 120 devices are positioned a known fixed distance from each other, the receivers are also positioned a known fixed distance from each other.

In a preferred embodiment of the present invention, the launcher 200 includes and/or utilizes a means of determining the orientation of the launcher, thereby determining the orientation of the second device 120 relative to the first device 110. In some such embodiments, a digital compass is utilized to determine the orientation of the launcher.

Some embodiments of the present invention include determining an azimuth angle, θ, of a local coordinate system (XL, YL, ZL). As is known in the art, the azimuth angle is measured from the global coordinate system in which X is oriented eastward, Y is oriented northward, and Z is oriented upward (the ENU coordinate system). In some such embodiments, the first position of the launcher 200 is positioned at local coordinates (0,0,0) and the second position of the launcher 200 is positioned at local coordinates (0,d,0). In other such embodiments, the second position of the launcher 200 is positioned at one or more other locations, such as (d,0,0) or (0,0,d), or even (dx,dy,0), (dx,0,dz), (0,dy,dz), or (dx,dy,dz).

In some embodiments in which the first and second positions of the launcher are located at local coordinates (0,0,0) and (0,d,0), respectively, the azimuth angle can be utilized to determine the position, in ENU coordinates, of the follower receiver relative to the master receiver, using the following equation:

ρ_{MF}(0)=(d·sin(θ),d·cos(θ),0) (Equation 6)

In some such embodiments, the launcher 200 includes one or more positioning feature 202 for locating the first 110 and second 120 devices at or near respective first and second positions of the launcher 200. In other such embodiments, the launcher includes one or more heading marker 204 so as to provide a user with guidance on how to orient the first 110 and second 120 devices on the launch pad. In some embodiments, the heading markers are parallel with each other.

In some embodiments, the first 110 and second 120 devices include one or more positioning feature that coordinates with the one or more positioning feature of the launcher. In some such embodiments, the one or more positioning features and/or the one or more markers are configured such that positioning the devices on the launcher and/or orienting the devices with the markers causes the receivers/antennas to be positioned at known vector distances from the positions of the launcher, thereby also causing the second receiver/antenna to be positioned at a known vector distance from the first receiver/antenna. For instance, in some embodiments, respective receivers/antennas of the first 110 and second 120 devices are positioned towards a tail end of each device but the devices are secured to the launcher at or near a mid-section in such a way that the tail section of the devices are allowed to rotate about their respective mid-sections. In some such embodiments, rotating each device until it is oriented with its respective heading marker causes the receiver/antenna of the second device 120 to be positioned a known vector distance from the receiver/antenna of the first device 110. In some embodiments, the known vector distance between receivers/antennas corresponds with and/or is equivalent to the vector distance between the first and second positions of the launcher.

In some embodiments, the launcher is relatively flat and level such that the local z axis aligns relatively well with the global z axis. In such embodiments, only the azimuth angle is necessary to convert local coordinates to global coordinates. In other embodiments, the launcher 200 is tilted in one or more direction such that the local z axis is angled from the global z direction. Some embodiments of the devices and/or the launcher include one or more features for determining the magnitude of such angles so as to more accurately determine the relative global positions of the first and second positions of the launcher.

Utilizing the launcher 200, x_{MF}(0) defined in Earth-Centered, Earth-Fixed coordinates (ECEF coordinates) can be estimated as

\hat{x}_{MF}(0)=R_{ENU}^{ECEF}·ρ_{MF}(0) (Equation 7)

where R_{ENU}^{ECEF} is a rotation matrix from the ENU coordinates to the ECEF coordinates at the master receiver's current location. Using this information, Equation 5 can be rewritten as

$$\begin{matrix}{δΦ}_{MF}^{kl} ( t , 0 ) = ∇ {ΔΦ}_{MF}^{kl} ( t ) - ∇ {ΔΦ}_{MF}^{kl} ( 0 ) \\ = - ( {1}_{M}^{k} ( t ) - {1}_{M}^{l} ( t ) ) \cdot {x}_{MF} ( t ) + \\ ( {1}_{M}^{k} ( 0 ) - {1}_{M}^{l} ( 0 ) ) \cdot {x}_{MF} ( 0 ) + \tilde{ε}\end{matrix} \qquad ( Equation 8 )$$

Then, the relative position difference, x_{MF}(t), is computed from the linear set of equations

$$\begin{matrix}\underbrace{[ \begin{matrix}{δΦ}_{MF}^{1 l} ( t , 0 ) - ( {1}_{M}^{1} ( 0 ) - {1}_{M}^{l} ( 0 ) ) \cdot {R}_{ENU}^{ECEF} \cdot {\hat{x}}_{MF} ( 0 ) \\ {δΦ}_{MF}^{2 l} ( t , 0 ) - ( {1}_{M}^{2} ( 0 ) - {1}_{M}^{l} ( 0 ) ) \cdot {R}_{ENU}^{ECEF} \cdot {\hat{x}}_{MF} ( 0 ) \\ ⋮ \\ {δΦ}_{MF}^{nl} ( t , 0 ) - ( {1}_{M}^{n} ( 0 ) - {1}_{M}^{l} ( 0 ) ) \cdot {R}_{ENU}^{ECEF} \cdot {\hat{x}}_{MF} ( 0 )\end{matrix} ]}_{Y} = \underbrace{[ \begin{matrix}- ( {1}_{M}^{k} ( t ) - {1}_{M}^{l} ( t ) ) \\ - ( {1}_{M}^{k} ( t ) - {1}_{M}^{l} ( t ) ) \\ - ( {1}_{M}^{k} ( t ) - {1}_{M}^{l} ( t ) ) \\ - ( {1}_{M}^{k} ( t ) - {1}_{M}^{l} ( t ) )\end{matrix} ]}_{G} \cdot {x}_{MF} ( t ) + \tilde{ε} and & ( Equation 9 ) \\ {\hat{x}}_{MF} ( t ) = {( {G}^{T} WG )}^{- 1} {WG}^{T} Y & ( Equation 10 )\end{matrix}$$

where W is the weighting matrix of the triple difference formulation.

It will be appreciated that, in some embodiments, the launcher includes a plurality of positions, each being displaced a known vector distance from the first position. In this way, an initial relative position vector x_{MF}(0) can be established for a receiver (M) associated with a master device and a plurality of receivers (F), each being associated with a follower device. In other embodiments, one or more initial position vector x_{FaFb}(0) can be established for a receiver (Fa) associated with a primary follower device, such as the second device 120, and another receiver (Fb) associated with one or more secondary follower device so as to more accurately determine the position of the secondary follower device relative to the position of the primary follower device.

### Cycle Slips

The present invention also pertains to a system for, and a method of, accurately detecting cycle slips. In some embodiments, a time series of triple difference measurements is utilized to detect cycle slips. More specifically, the current value of the triple difference is compared to the mean and standard deviation of the last n triple differences. In some such embodiments, a cycle slip is declared when the following condition is met

δΦ_{MF}^{kl}(t, 0)>|μ±k_{inf}·σ| (Equation 11)

where μ and σ are the mean and standard deviation of the triple difference for the last n epochs, respectively, and k_{inf} is an inflation factor of σ. In some embodiments, reliable cycle slip detection is obtainable with nine epochs of previous triple difference measurements using an inflation factor (k_{inf}) of 7. In some such embodiments, assuming δΦ_{MF}^{kl}(t, 0) follows Gaussian distribution, k_{inf} of 7 corresponds with a false alert probability of 1.83×10-11. In other such embodiments, five (5) measurements are taken per second such that the nine (9) epochs represent approximately two seconds of previous triple difference measurements.

In some embodiments, the direction cosine vectors in Equation 5 do not vary much over a short time period of less than a few minutes. In some such embodiments, the characteristics of the time series of the triple difference would mainly depend on the dynamics of the relative position. In other such embodiments, n and k_{inf}, largely depend on user dynamics and should be accordingly determined. For instance, in some embodiments, a lower n value is required for devices moving at higher rates of speed. In other embodiments, measurements must be taken at more frequent intervals so that each epoch defines a shorter amount of time.

By accurately detecting cycle slips, the present invention is also capable of determining whether another systems' cycle slip warnings are valid. For instance, if another system, such as an RTK GPS system, provides an indication that a cycle slip may have occurred, some embodiments of the present invention are capable of either validating the cycle slip warning (if a cycle slip has in fact occurred) or discrediting the cycle slip warning (if a cycle slip has not occurred), whichever the case may be. In this way, the often incorrect cycle slip notifications are less likely to interfere with actions, such as formation flights, that require continuous, accurate, relative positioning information. In other embodiments, detection of false cycle slip warnings are utilized to prevent large position estimation errors that are often associated with false cycle slip warnings. In still other embodiments, detection of false cycle slip warnings enables a system to forego the heavy computation loads and long re-initialization times associated with resolving integer ambiguities after a cycle slip has occurred.

### System Flowchart

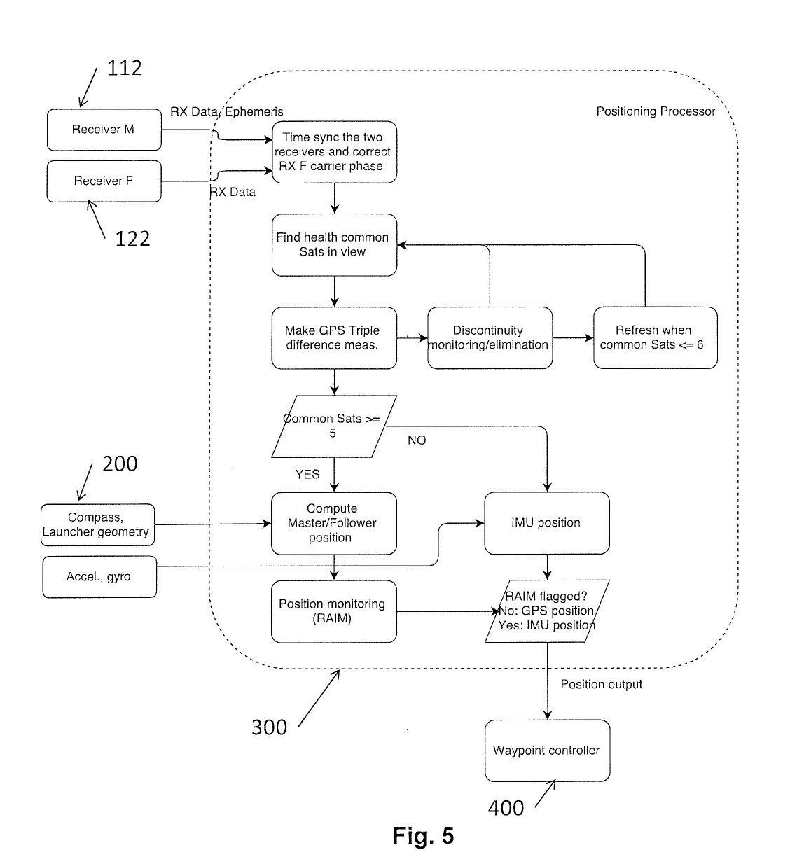

Referring to the flowchart in FIG. 5, a preferred embodiment of the present invention includes a positioning processor 300 that receives information from the first/master receiver 112 and the second/follower receiver 122. In some embodiments, the information includes GNSS measurement information and/or other information. In some such embodiments, the information includes GNSS time of week, carrier phase, Doppler, ephemeris, and/or other receiver and satellite health messages. In some embodiments, the time when the measurements are taken is slightly different for each receiver. In some such embodiments, the carrier phase measurements of the follower device are corrected by using Doppler measurements as follows

Φ_{c}(t_{M})=Φ(t_{F})+ν_{F}(t_{F})·Δt_{MF}·λ_{L1} (Equation 12)

where Φ_{c}(t_{M}) is the corrected carrier phase measurement that corresponds with the measurement time t_{M} at the master receiver; Φ(t_{F}) is the carrier phase measurement that is taken in the follower receiver at time t_{F}; ν_{F} is the Doppler measurement of the follower receiver; Δt_{MF}, which is typically on the order of milliseconds, is time offset between the measurements at the master and follower receivers; and λ_{L1} is a GNSS L1 frequency wavelength.

In a preferred embodiment, the follower GNSS measurements are corrected, the positioning processor 300 finds common satellites in view of each receiver, and triple differences are computed. In some embodiments, the time series of the triple differences are used by a monitoring sub-function that continuously checks for cycle slips in the carrier phase measurements. In some such embodiments, the sanity of the computed relative position is checked by a position monitoring function, such as a Receiver Autonomous Integer Monitoring (RAIM) function. In some embodiments, the position monitoring function utilizes the maximum solution separation technique. It will be appreciated that, in other embodiments, other methods or techniques are utilized in conjunction with or in place of the maximum solution separation technique.

In some embodiments, the relative position between the master 112 and follower 122 receiver is computed when the number of common satellites in view of the devices is more than or equal to five. In other embodiments, the relative position is not computed if the position monitoring function, such as the RAIM, indicates possible faults in the computed position due to undetected cycle slips. In still other embodiments, the relative position is not computed when the number of common satellites is below five.

In some embodiments, the positioning processor 300 uses one or more Inertial Measurement Unit (IMU) driven position solution when relative positioning is not otherwise being computed and/or when relative positioning is deemed unreliable. In some such embodiments, relative positioning is not computed and/or is deemed unreliable when the number of common satellites is less than five. In other such embodiments, relative positioning is not computed and/or is deemed unreliable when the position monitoring function indicates possible faults in measurements associated with one or more satellite, such as when the RAIM or other position monitoring function indicates possible faults in the computed position due to undetected cycle slips. In other words, in some embodiments, relative positioning is not computed and/or is deemed unreliable when one or more measurement is brought into doubt and/or is otherwise considered unreliable. For instance, in some embodiments, the IMU is used even if five or more common satellites are in view of each device but measurements associated with one or more satellite are brought into doubt such that reliable measurements from five common satellites are not available.

In some embodiments, the use of IMU is limited to a short time, such as a couple of seconds or less. In this way, potential drift associated with use of the IMU driven position is minimized or eliminated. In some such embodiments, the devices are directed away from each other and/or are otherwise removed from a mission when reliable positioning information is not available for the device.

### Categorizing Signals

In a preferred embodiment, the system is capable of categorizing position reliability of each device. In some embodiments, position reliability for a particular device is obtained by categorizing the link between the device and each satellite (the signal) as either uninterrupted, unaffected, unsubstantiated, reliable, and/or unreliable.

In some embodiments, a signal is categorized as being uninterrupted if, from the time the device was positioned on the launcher 200, the device has never lost connection with the signal. In some such embodiments, an uninterrupted signal provides the most reliable relative positioning information.

In some embodiments, a signal is categorized as being unaffected if, from the time the device was positioned on the launcher 200, it is determined that a cycle slip did not occur during any loss in connection with the signal. In some such embodiments, an unaffected signal cannot be re-categorized as an uninterrupted signal unless it is later determined that the signal was never lost in the first place (in which case the signal should have always been categorized as an uninterrupted signal). In some embodiments, an unaffected signal provides the second-most reliable relative positioning information.

In some embodiments, a signal is categorized as being unsubstantiated if the signal has been lost and regained but it has not yet been determined whether a cycle slip has occurred. In some such embodiments, an unsubstantiated signal is re-categorized as an unaffected signal if it is later determined that a cycle slip did not occur. In other such embodiments, an unsubstantiated signal is later re-categorized as a reliable signal or an unreliable signal if it is determined that a cycle slip has occurred.

In other embodiments, a signal is categorized as being unsubstantiated if the signal was not received when the device was in the launcher 200. In other words, in some embodiments, new signals are initially categorized as unsubstantiated signals. In some such embodiments, new signals are later re-categorized as reliable signals or as unreliable signals.

In some embodiments, unsubstantiated signals are assessed for reliability. In some such embodiments, the reliability of the signal is determined by determining the relative position of the device using two different sets of signals. The first set includes one or more unsubstantiated signal and a plurality of uninterrupted, unaffected, and/or reliable signals and the first set only includes uninterrupted, unaffected, and/or reliable signals. In some such embodiments, the signal is re-categorized as a reliable signal if a relative positioning difference associated with the two different sets of signals is within an allowable threshold. In other such embodiments, the signal is re-categorized as an unreliable signal if the relative positioning difference is greater than the allowable threshold.

In some embodiments, reliable and unreliable signals are regularly assessed to determine whether they should be re-categorized. In some such embodiments, uninterrupted signals and/or unaffected signals are also categorized as reliable signals. In other such embodiments, unsubstantiated signals are also categorized as unreliable signals.

In some embodiments, position reliability for a particular device is obtained by categorizing the link between the device and each satellite (the signal) as either uninterrupted, unaffected, unsubstantiated, reliable, and/or unreliable.

In some embodiments, the relative position between two devices is categorized based on the common signals associated with those devices. In some such embodiments, the relative position is categorized as uninterrupted if at least five common signals are categorized as uninterrupted for each device. In other such embodiments, the relative position is categorized as unaffected if at least five common signals are categorized as uninterrupted and/or unaffected for each device. In still other such embodiments, the relative position is categorized as reliable if at least five common signals are categorized as uninterrupted, unaffected, and/or reliable for each device. In yet other such embodiments, the relative position is categorized as unsubstantiated and/or unreliable if the relative position is not categorized as uninterrupted, unaffected, and/or reliable.

### Controller

In a preferred embodiment, the system includes a controller 400 for controlling one or more device. In some embodiments, the controller 400 receives information from the positioning processor 300 and provides information to the first device so as to control the movement of the first device. In some such embodiments, control of the first device 110 also controls the second device 120 because the second device 120 is pre-programmed to follow the first device 110. In other such embodiments, the controller 400 includes one or more feature for controlling the second device 120 independent of or in conjunction with the first device 110. For instance, some embodiments of the controller 400 include a first means of causing the first device 110 to perform a clockwise barrel roll and a second means for selectively causing the second device to perform a clockwise barrel roll, to perform a counter-clockwise barrel roll, or to prevent the second device from performing a barrel roll at all.

In some embodiments, the controller limits functions based on the category of one or more relative position associated with two or more devices. In some such embodiments, the controller enables complex and/or close-proximity functions for devices having an uninterrupted and/or unaffected relative position. In other such embodiments, the controller restricts some or all of the complex and/or close-proximity functions for devices having a reliable or unsubstantiated relative position. In still other embodiments, the controller restricts all complex and/or close-proximity functions and/or requires the devices to move away from each other when for devices having an unreliable relative position.

In some such embodiments, the follower device becomes the master device and the master device becomes a follower device. In some such embodiments, some or all of the follower devices having unreliable relative positions with the master device are removed from the formation and/or are delegated to less complex functions and/or are moved away from devices for which there are unreliable relative positions.

### Other Applications

It will be appreciated that the current inventive system and methods can be utilized with one, two, or even no GNSS satellites at all. In some such embodiments, one or more other reference device is utilized in place of one or more GNSS satellite. For instance, in some embodiments, the present system and methods are utilized in an enclosed area, such as a gymnasium, a concert hall, or any other enclosed area. In some such embodiments, a plurality of reference devices are positioned at known locations throughout the enclosed area such that the devices are capable of receiving a signal from each of a plurality of such reference devices so as to determine the relative position of each device without the use of any GNSS satellites at all. In other embodiments, one or more reference device is positioned in an open area, such as on a radio tower, a building, a bridge, a flagpole, or any other stationary object. In some such embodiments, one or more reference device is used in conjunction with one or more GNSS satellite so as to determine the relative position of each device. In still other embodiments, one or more reference device is positioned on a moving object, such as an aircraft, a ship, an automobile, one or more of the devices, and/or any other moving and/or movable object. In some such embodiments, one or more mobile reference device is used in conjunction with one or more stationary reference device and/or with one or more GNSS satellite so as to determine the relative position of each device.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A method for coordinating movement of two devices, the method comprising:
utilizing a launcher to establish an initial relative position vector between first and second devices;
utilizing the initial relative position vector to calculate triple difference measurements associated with said first and second devices; and
determining relative position of said first and second devices based on the triple difference measurements.

2. The method of claim 1, wherein said launcher includes first and second locations for positioning respective first and second devices so that said first and second devices can be positioned a known distance from each other, thereby enabling the establishment of the initial relative position vector.

3. The method of claim 2, wherein the launcher further includes a positioning feature at or near the first and second locations for selectively securing respective first and second devices at or near respective first and second locations.

4. The method of claim 2, wherein the launcher includes one or more heading marker so as to provide a user with an indication of how to orient the devices on the launcher.

5. The method of claim 2, wherein establishing the initial relative position vector includes positioning said first and second devices at or near respective first and second locations such that said first and second devices are positioned a known vector distance from each other.

6. The method of claim 5, wherein utilizing the initial relative position vector to calculate triple difference measurements includes:
receiving by each of said first and second devices at least one signal from each of a plurality of common GNSS satellites;
associating the signals with a received time;
processing the signals from the common GNSS satellites so as to determine a plurality of packets of current information, each packet of current information including satellite clock information, receiver clock information, and satellite position information;
comparing information from the packets of current information so as to determine the current location of the second device relative to the current location of the first device; and
comparing information from the packets of current information with information from packets of previous information,
wherein the second device is positioned within a few kilometers of the first device,
wherein the packet of previous information includes information pertaining to the initial relative position vector.

7. The method of claim 6, wherein:
comparing information from the packets of current information reduces relative position inaccuracies associated with errors in satellite clock information and receiver clock information, and
comparing information from the packets of current information with information from the packets of previous information further reduces relative position inaccuracies.

8. The method of claim 6, wherein the signal from each of the common GNSS satellites was received by each of said first and second devices when the initial relative position vector was established.

9. The method of claim 8, wherein the signal from each of the common GNSS satellites was continuously received, uninterrupted, between the time of establishing the initial relative position vector and calculating the current triple difference.

10. The method of claim 8, wherein any interruptions in the signal from each of the common GNSS satellites between the time of establishing the initial relative position vector and calculating the current triple difference did not result in a cycle slip.

11. The method of claim 8, wherein the signal from one or more of the common GNSS satellites was validated by comparing relative positions associated with the validated signal with relative positions associated with signals from a plurality of other GNSS satellites, wherein the signal from each of the other GNSS satellites was continuously received, uninterrupted, between the time of establishing the initial relative position vector and validating the validated signal.

12. The method of claim 8, wherein the signal from one or more of the common GNSS satellites was validated by comparing relative positions associated with the validated signal with relative positions associated with signals from a plurality of other GNSS satellites, wherein any interruptions in the signal from each of the signals from the other GNSS satellites between the time of establishing the initial relative position vector and validating the validated signal did not result in a cycle slip.

13. A method of determining whether a cycle slip has occurred, the method comprising:
calculating a current triple difference measurement for first and second devices; and
comparing the current triple difference measurement with previous triple difference measurements for said first and second devices.

14. The method of claim 13, wherein the method of determining whether a cycle slip has occurred for a signal is utilized to determine the reliability of the signal.

15. The method of claim 13, wherein the method of determining whether a cycle slip has occurred for a signal is utilized to determine whether a cycle slip warning is valid.

16. The method of claim 13, wherein comparing the current triple difference measurement with previous triple difference measurements includes determining the mean and standard deviation of the last n triple differences and determining whether the current triple difference measurement falls within a range associated with the mean and standard deviation, the range being extending a predetermined factor of the standard deviation on either side of the mean deviation.

17. The method of claim 13, wherein the predetermined factor is an inflation factor of 7, n is nine, and five measurements are taken each second such that each epoch has a duration of one-fifth of a second and the total duration of epochs utilized to develop the range is approximately two seconds.
